(19) United States
(12) Patent Application Publication
(10) Pub. No.: US 2016/0205911 A1
(43) Pub. Date: Jul. 21, 2016

(54) COMPOSITE PADDLE AND INTERLOCKING KEEL

(71) Applicants: Joseph William Jarboe, JR., Fort Smith, AR (US); Munenori Suzuki, Kasuga-Shi (JP)

(72) Inventors: Joseph William Jarboe, JR., Fort Smith, AR (US); Munenori Suzuki, Kasuga-Shi (JP)

(73) Assignee: EBSCO Industries, Inc., Birmingham, AL (US)

(21) Appl. No.: 14/993,870

(22) Filed: Jan. 12, 2016

Related U.S. Application Data
(60) Provisional application No. 62/103,737, filed on Jan. 15, 2015.
(60) Provisional application No. 62/117,188, filed on Feb. 17, 2015.

(51) Int. Cl. A01K 85/18

(52) U.S. Cl. CPC A01K 85/18

(57) ABSTRACT

A paddle and keel assembly for a hard bodied fishing lure utilizes a paddle having locking holes there through and a pull-point slot there through with a keel molded to one surface thereof and extending through the locking holes to secure the paddle to the keel and a wire-form within the pull-point slot such that all of the components are fixed in the x-y-z coordinates.

### FIELD OF INVENTION

The present invention relates to fishing lures and more specifically to the attachment of a diving paddle and or pull-point to a hard body lure. More particularly the present invention relates to an interlocking paddle and keel design that improves the strength and precision alignment ability of a fishing lure.

### BACKGROUND

Many fishing lures use paddles, made from fiberglass epoxy laminate material or similar rigid material, that are glued into a slot in the fishing lure and then hand tuned to make the lure swim straight. Such hand tuning is often required due to misalignment of the paddle with the lure. Consequently, a need exists to improve the mounting of the paddles to the lures to reduce the misalignment and minimize that amount of hand tuning. Fishing lures known to the inventor generally use symmetric diving paddles to control the depth at which hard bodied lures, also known as crankbaits, run when retrieved using bait casting equipment. Such lures run in a nose down configuration such that the paddle or blade often encounters the obstruction such as tree limbs before the lure body or the hooks. Typically, the pull point to which the retrieving line is connected is attached along the centerline of the diving paddle. The location of the pull ring has been considered necessary to enable the lure to run true when retrieved. Consequently, manual manipulation of the pull ring without a full understanding of the physics leads to an unstable and erratically retrieved lure.

### SUMMARY OF THE INVENTION

A general object of the invention is to improve the strength and precision alignment ability of a paddle to a fishing lure. To accomplish this, we use a molded keel which is inserted precisely into the lure body to insure that the attached paddle is correctly positioned.

Another general object of the invention is to prevent fishing lures from hanging up on underwater obstructions such as submerged tree limbs and rocks.

In one embodiment, a crankbait is equipped with an eccentric paddle that will deflect causing the lure to rotate away from the obstruction.

In accordance with another embodiment, a crankbait is equipped with an eccentric paddle of an opposite eccentricity to cause deflection.

### BRIEF DESCRIPTION OF THE DRAWINGS

Referring to the drawings which are appended hereto and which form a portion of this disclosure, it may be seen that:

FIG. 1 is an exploded view of a paddle pull-point wire form and molded keel;

FIG. 2 is a side elevation view of a crankbait or other hard body lure showing a slot for receiving the paddle and keel assembly in place.

FIG. 3 is a sectional view of a crankbait or other hard body lure with the paddle and keel assembly in place.

FIG. 4 is a plan view of a preferred paddle;

FIG. 5 is a perspective view of the preferred paddle affixed to the keel and inserted into the body.

FIG. 6 is perspective view of one embodiment of the paddle on a crankbait encountering an obstruction;

FIG. 7 is a perspective view of the embodiment of FIG. 1 rotating to avoid snagging on the obstruction.

FIG. 8 is a side elevational view of a second embodiment of the paddle and keel . . .

FIG. 9 is a plan view of a second embodiment of the paddle;

FIG. 10 is a sectional view taken along line 10-10 of FIG. 9;

FIG. 11 is a sectional view taken along line 11-11 of FIG. 9.

FIG. 12 is a perspective view of a third embodiment of the paddle and keel;

FIG. 13 is an exploded view of the third embodiment; and

FIG. 14 is a side elevation view of the paddle in the third embodiment.

### DETAILED DESCRIPTION

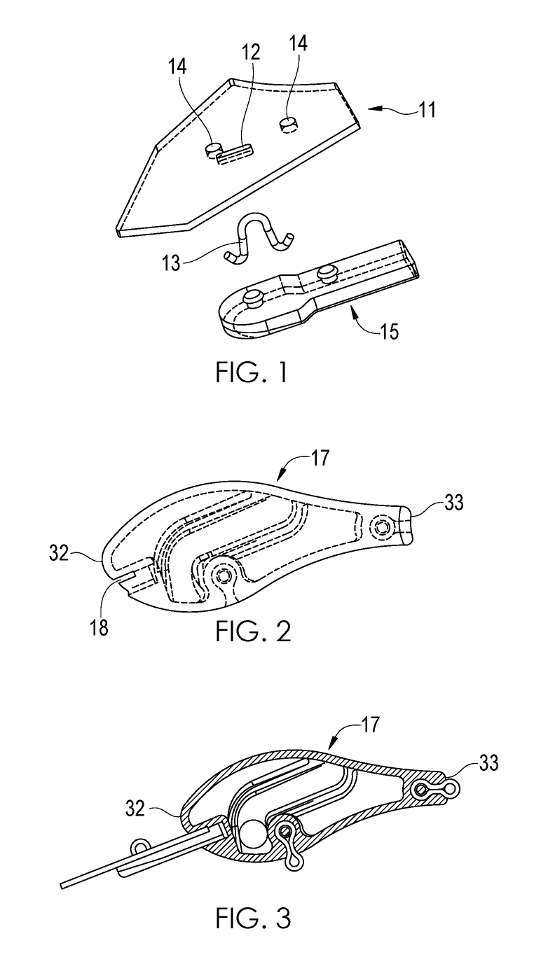

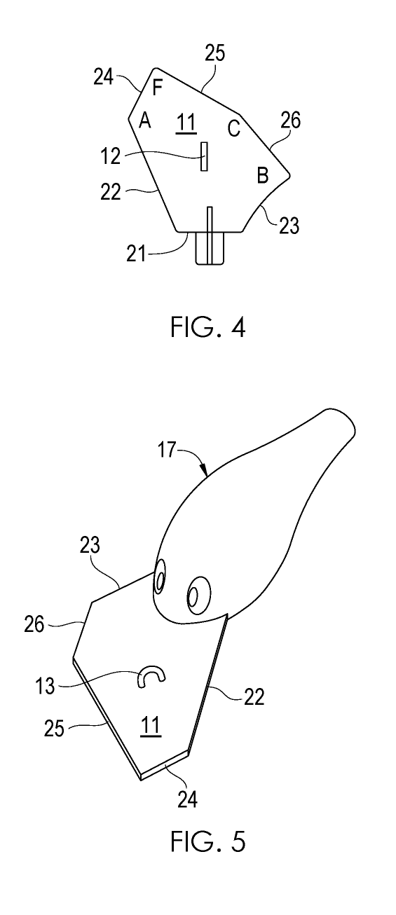

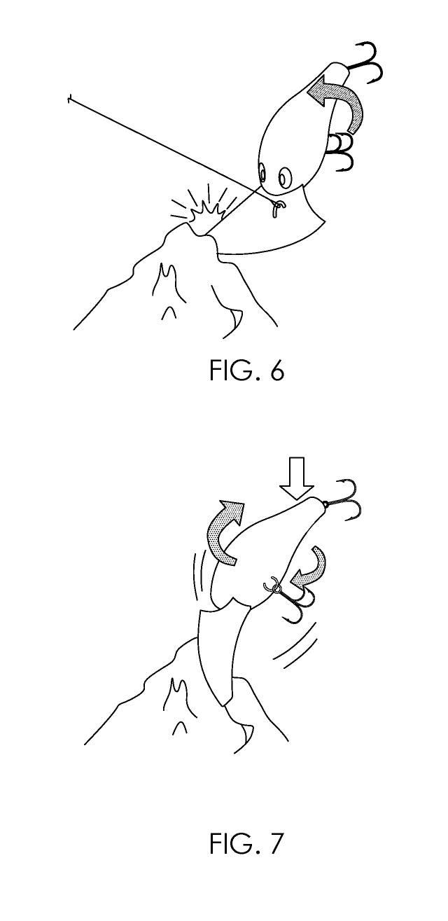

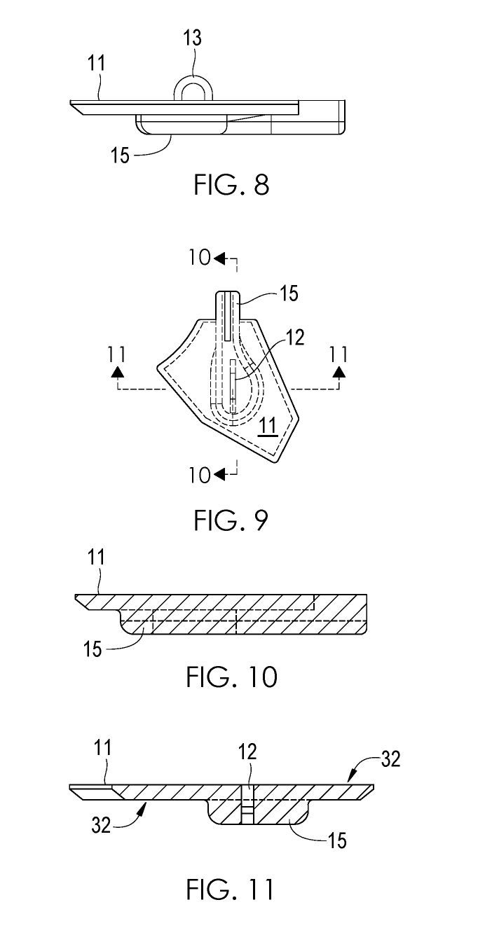

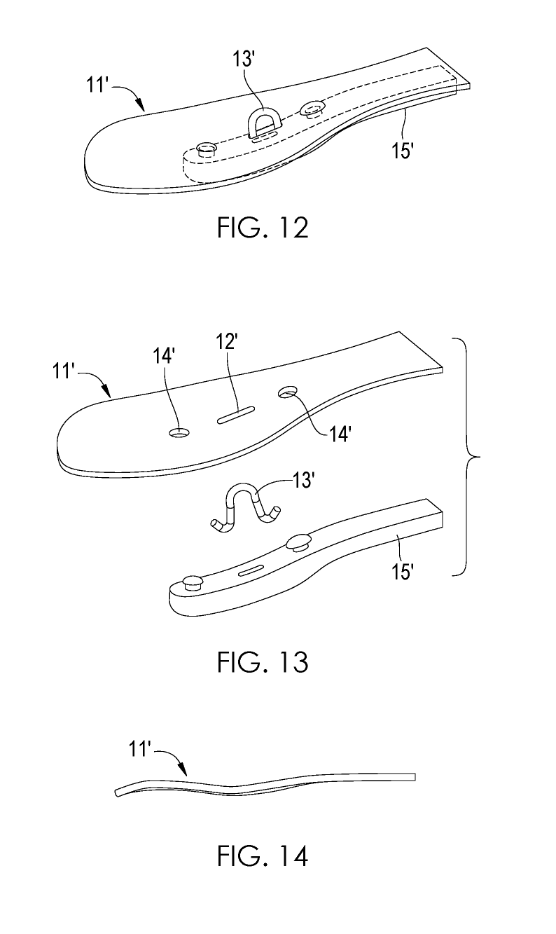

One or more of the above objects can be achieved, at least in part, by providing an assembly that is insert molded to precisely align the paddle top, pull-point and keel. Referring to FIG. 1, note that in this embodiment a paddle 11 is provided with a slot 12 through which a wire-form pull-point 13 can be inserted such that a closed eye E is formed by the paddle and pull-point. The paddle is punched with the slot 12 in an appropriate position and with a pair of locking holes 14 which may assume any configuration, i.e. round, square, oblong, slotted. The punched paddle 11 and pull-point 13 are inserted into a precision pocket in an injection mold. The mold is closed and injected with a plastic that flows through the locking holes 14 and slot 12, then hardens to form a rigid keel 15 locking the pull-point 13 to the paddle 11 and the paddle 11 to the keel 15. This process precisely aligns the paddle 11, keel 15 and pull-point 13 in the X, Y and Z planes with the resultant assembly ready to be inserted into the lure body 17.

The pull-point 13 may also be precisely aligned through thermal staking of the pull-point 13 into the paddle 11. In thermal staking a metal pull-point 13 is placed in a cored or drilled hole in paddle 11 which is slightly smaller than the insert. This hole provides a certain degree of interference and also serves to guide the pull-point wire-form into place. The heat from the thermal tip travels through the pull-point to the interface of the metal and plastic. Heat generated by the thermal tip causes the plastic in the paddle 11 to melt, and as the thermal tip advances, the pull-point is imbedded into the paddle. The molten plastic flows into the serrations, lobes, or undercuts of the pull-point, and when the heat terminates, the plastic re-solidifies and the pull-point 13 is securely encapsulated in place in paddle 11. Of course the exact configuration of the wire form pull point may vary so long as it extends through the paddle and is imbedded in the

The paddle 11 may be of any shape and any suitable material and the pull-point 13 and cooperative slot 12 may be placed on the centerline of the lure body 17 or on either side thereof as needed to enhance the action of the lure in the water. Referring to FIG. 2, a mouth slot 18 is formed in the molded lure body 17 to accept the cross section of the paddle assembly such that the keel 15 and paddle 11 mate precisely with the lure body 17. The paddle assembly can be affixed to the lure body 17 by sonic welding or gluing as appropriate. It may be seen in FIG's 8 to 11, that the paddle and keel may be a unitary molded unit with the pull point 13 embedded therein.

In a preferred embodiment we utilize an asymmetrical paddle 11 or lip on a hard body 17 or crankbait style fishing lure to deflect under water cover easier by placing an off-center pull-point 13 on the paddle 11. Referring to the figures for a better understanding of the invention, note that the lures to which the present invention are connected are generally balanced and contain a weight within a lightweight balsa or plastic body 17. Body 17 includes a nose 32 and a tail 33 along with hook hangers and hooks (not shown) suspended below the body 17. A transverse mouth slot 18 is formed in body 17 slightly below nose 32. The inclination of the slot 18 relative to the center horizontal plane of the body 17 varies depending on the depth at which the lure is expected to run when pulled through the water by a fishing line, not shown, connected to a pull point 13 mounted on a paddle 11 inserted into slot 18 and secured therein.

Paddle 11 differs from known prior art paddles in that such paddles have been symmetric about their longitudinal axis or about the longitudinal axis of the lure to which they were attached. Consequently, the pull point of prior art lures has typically been along the center line of the paddle or the lure. In the embodiment shown in the figures, the paddle has a pair of asymmetrical lobes or sides. The paddle shape includes a base edge 21 which is inserted into slot 18 and a first lateral edge 22 defining an included angle of more than 90 degrees with base edge 21. First lateral edge 22 thus extends from slot 18 outwardly and forwardly of body 17 below nose 32. A second lateral edge 23 extends from the end of base edge 21 outwardly at a slightly greater angle than first lateral edge 22, thus the first and second lateral edges converge toward base edge 21 but at different rates. A forward edge 24 extends from the forward-most extension of first lateral edge 22 toward the centerline of body 17 forming an obtuse angle with first lateral edge 22 at junction A. A leading edge 25 joins forward edge 24 and crosses the centerline of body 17 forming a slightly acute angle with forward edge 24 at junction F. A secondary leading edge 26 extends between leading edge 25 and the end of second lateral edge 23 forming an obtuse angle with leading edge 25 at junction C and a slightly acute angle with second lateral edge 23 at junction B. Accordingly first lateral edge 22 forward edge 24 and leading edge 25 define the boundaries of a major lobe 31 existing on one side of the centerline of body 17. This major lobe 31 defines the forward most extension of paddle 10. Leading edge 25, secondary leading edge 26 and second lateral edge 22 define the outer boundary of the second lobe 32 of paddle 10 existing on the opposite side of the centerline of body 17. Thus leading edge 25 extends transversely of the centerline from the forward most part of the paddle 10 and rearwardly to connect with secondary leading edge 26.

It should be understood that each edge described herein above may be linear or may be slightly curved and each angle defined by the intersection of the edges is to be considered an included angle but the physical connection of the edges may be rounded or pointed. Likewise, leading edge 25 and secondary leading edge 26 may form a single curved leading edge extending from forward edge 24 at junction F to second lateral edge 22 at junction B.

Line-eye or pull point 13 is mounted within major lobe 31 off the centerline of body 17. With the line-eye off the centerline and with major lobe 31 extending in front of the lure, if the lure encounters an obstacle it will be when the leading edge 25 and forward edge 24 are below the level of the body 17 such that they encounter the obstacle. As illustrated in FIG.'s 6 and 7, because the line eye is not on the centerline of the lure, if the obstruction is encountered between junction F and junction A, the lure will pivot about the contact point between the lip and the obstruction until the lure is vertical at which time tension on the line will move the lure past the obstruction. If the obstruction is encountered between junction F and junction B, the lure will simply slide around the obstruction and remain free. The various permutations are illustrated in the figures. With respect to Y shaped tree limbs note that it is more likely that the major lobe will encounter one branch of the Y before the minor lobe, thus any pivoting action of the lure well begin before both lobes are engaged.

Note that the position of the line-eye 13 along the length of paddle 11 may be varied to impart different swim characteristics to the lure and the angle of slot 18 can be varied to also impart different swim characteristics, however, in most instances the lure will “swim” in a nose down configuration relative to a horizontal plane such that the edge of the paddle will be the first point to encounter an obstruction and the belly hooks 16 will be shielded from the obstruction by the paddle. As the paddle flips, pivots or slides by the obstruction the hooks 16 should also avoid the obstruction.

In a third embodiment shown in FIG's 12 to 14, the keel 15′ is adapted to mate with a paddle 11′ which is undulating or non-planar. In this embodiment the keel is formed with an undulating upper surface 41 which matches the undulation of the paddle 11′. As in the preceding embodiments, a punched paddle 11′ and pull-point 13′ are inserted into a precision pocket in an injection mold. The mold is closed and injected with a plastic that flows through the locking holes 14′ and slot 12′, then hardens to form a rigid keel 15′ locking the pull-point 13′ to the paddle 11′ and the paddle 11′ to the keel 15′, thus precisely aligns the paddle 11′, keel 15′ and pull-point 13″ in the X, Y and Z planes with the resultant assembly ready to be inserted into the lure body 17.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

What we claim is:

1. A diving paddle assembly for use with a hard bodied fishing lure comprising:
a. A paddle having at least one edge dimensioned to be inserted into a slot formed in the front of said hard bodied fishing lure, said paddle having a plurality of orifices formed there through;
b. A wire-form dimensioned to extend through at least one of said plurality of orifices to form a loop extending from one surface of the paddle and having opposing ends extending beyond said at least one of said plurality of orifices on an opposite surface of said paddle; and
c. A plastic keel affixed to said opposite surface of said paddle and encasing said opposing ends of said wire-form and extending through said plurality of orifices to secure said paddle to said keel, such that the paddle, keel, and wire-form are precisely aligned in orthogonal planes said keel having a portion thereof extending contiguously with said paddle into said slot in the front of said hard bodied fishing lure and secured thereto.

2. A diving paddle assembly as defined in claim 1 wherein said plastic keel extends forwardly from said hard bodied fishing lure on either side of a vertical plane passing longitudinally through said hard bodied fishing lure.

3. A diving paddle assembly as defined in claim 2 wherein said plurality of orifices include at least one locking hole formed through said paddle and at least one slot formed through said paddle, wherein said loop extends through said slot and is embedded in said plastic keel and said plastic keel is fixedly engaged within said at least one locking hole.

4. A diving paddle assembly as defined in claim 3 wherein said at least one slot is offset from said vertical plane.

5. A diving paddle assembly as defined in claim 1 wherein said plurality of orifices include at least one locking hole formed through said paddle and at least one slot formed through said paddle, wherein said loop extends through said slot and is embedded in said plastic keel and said plastic keel extends through said at least one locking hole.

6. A diving paddle assembly as defined in claim 1 wherein said plurality of orifices includes at least one slot formed through said paddle of sufficient size for said loop to pass through while resisting the passage of opposing ends there through, said opposing ends further being embedded in said plastic keel.

7. A diving paddle assembly as defined in claim 6 wherein said plastic keel extends forwardly from said hard bodied fishing lure on either side of a vertical plane passing longitudinally through said hard bodied fishing lure and said at least one slot is offset from said vertical plane.

8. A diving paddle assembly as defined in claim 1 wherein said plurality of orifices include a plurality of locking holes through which a portion of said plastic keel extends and is secured within.

9. A diving paddle assembly as defined in claim 1 wherein said paddle is undulating in shape.

10. A diving paddle assembly as defined in claim 1 wherein said paddle is substantially planar.

11. A diving paddle assembly for use with a hard bodied fishing lure comprising:
a. A paddle having at least one edge dimensioned to be inserted into a slot formed in the front of said hard bodied fishing lure, said paddle having at least one slot formed there through;
b. A wire-form dimensioned to extend through said at least one slot to form a loop extending from one surface of the paddle and having opposing ends extending beyond said at least one slot on an opposite surface of said paddle; and,
c. A plastic keel affixed to said paddle and said wire form for insertion into the front of said hard bodied fishing lure,
Wherein said paddle has a major lobe extending on one side of said keel and a minor lobe extending on an opposite side of said keel.

12. A diving paddle assembly as defined in claim 11 wherein said plastic keel extends forwardly from said hard bodied fishing lure on either side of a vertical plane passing longitudinally through said hard bodied fishing lure and said major lobe and said minor lobe extend in opposite directions perpendicular to said vertical plane.

13. A diving paddle assembly as defined in claim 12 wherein said at least one slot is offset from said vertical plane.

14. A diving paddle assembly as defined in claim 12 wherein said major lobe defines the forward-most extension of said paddle assembly.

15. A diving paddle assembly as defined in claim 11 wherein said paddle is defined by a base edge which is inserted into said slot and a first lateral edge defining an included angle of more than ninety degrees with said base edge, said first lateral edge extending from said base edge and slot outwardly and forwardly of said body, a second lateral edge extending from said base edge outwardly at a greater angle than first lateral edge, such that the first and second lateral edges converge toward base edge at different rates; a forward edge, extending from a forward-most extension of first lateral edge, toward a centerline of said body forming an obtuse angle with first lateral edge; a leading edge joining said forward edge and crossing said centerline of said body forming a slightly acute angle with said forward edge at a junction therewith, said first lateral edge, forward edge and leading edge defining the boundaries of a major lobe extending on one side of the centerline of said body.

16. A diving paddle assembly as defined in claim 15 wherein said major lobe defines the forward most extension of said paddle.

17. A diving paddle assembly as defined in claim 15 further comprising a secondary leading edge extending between said leading edge and an outward end of second lateral edge forming an obtuse angle with leading edge at a junction therewith and a slightly acute angle with second lateral edge at a junction therewith.

18. A diving paddle assembly as defined in claim 17 wherein said leading edge, secondary leading edge and second lateral edge define the outer boundary of a second lobe of said paddle extending on the opposite side of the centerline of body from said major lobe wherein, said leading edge extends transversely of the centerline from the forward most part of the paddle and rearwardly to connect with said secondary leading edge.

19. A diving paddle assembly for use with a hard bodied fishing lure comprising:
a. A paddle having at least one edge dimensioned to be inserted into a slot formed in the front of said hard bodied fishing lure, said paddle having at least two locking holes formed there through;
b. A pull loop extending from a surface of said paddle; and
c. A plastic keel molded to an opposite surface of said paddle and encasing said pull loop and extending through said locking holes to secure said paddle to said keel, such that the paddle, keel, and pull loop are precisely aligned in orthogonal planes said keel having a portion thereof extending contiguously with said paddle into an opening formed in the front of said hard bodied fishing lure and secured thereto.

20. A diving paddle assembly as defined in claim 19 wherein said paddle is undulating in shape.

21. A diving paddle, for use with a hard bodied fishing lure, comprising a substantially flat body having at least one edge dimensioned to be inserted into a slot formed in the front of said hard bodied fishing lure wherein said paddle has a major lobe extending on one side of said slot and a minor lobe extending on an opposite side of said.

22. A diving paddle as defined in claim 21 wherein said flat body is defined by a base edge which is insertable into said slot and a first lateral edge defining an included angle of more than ninety degrees with said base edge, said first lateral edge extending from said base edge outwardly and forwardly of said base edge, a second lateral edge extending from said base edge outwardly and forwardly at a greater angle than first lateral edge, such that the first and second lateral edges converge toward base edge at different rates; a forward edge, extending from a forward-most extension of first lateral edge, toward a centerline of said body forming an obtuse angle with first lateral edge; a leading edge joining said forward edge and crossing said centerline of said flat body forming an acute angle with said forward edge at a junction therewith, said first lateral edge, forward edge and leading edge defining the boundaries of a major lobe extending on one side of the centerline of said body.

23. A diving paddle assembly as defined in claim 21 wherein said major lobe defines the forward most extension of said paddle.

24. A diving paddle assembly as defined in claim 22 further comprising a secondary leading edge extending between said leading edge and an outward end of second lateral edge forming an obtuse angle with leading edge at a junction therewith and a slightly acute angle with second lateral edge at a junction therewith.

25. A diving paddle assembly as defined in claim 24 wherein said leading edge, secondary leading edge and second lateral edge define the outer boundary of a second lobe of said paddle extending on the opposite side of the centerline of said flat body from said major lobe wherein, said leading edge extends transversely of the centerline from the forward most part of the flat body and rearwardly to connect with said secondary leading edge.
